(19) United States
(12) Patent Application Publication
(10) Pub. No.: US 2019/0182195 A1
(43) Pub. Date: Jun. 13, 2019

(54) Event-Based Scoring of Communication Messages

(71) Applicant: Knowmail S.A.L LTD., Petach-Tikva (IL)

(72) Inventors: Oded Avital, Tiqua (IL); Avi Mandelberg, Hod Ha'Sharon (IL); Yury Gubman, Jerusalem (IL); Shmuel Ur, Shorashim (IL)

(21) Appl. No.: 15/840,415

(22) Filed: Dec. 13, 2017

(51) Int. Cl. H04L 12/58

(52) U.S. Cl. CPC H04L 51/22; H04L 67/18

(57) ABSTRACT

A system, method and product for event-based scoring of communication messages. An external event is obtained. The external event is external to a communication system through which a user received a plurality of communication messages. In response to the external event, scores to the plurality of communication messages are computed, wherein each score is computed based on a relevancy measurement of a respective communication message to the external event. A display of the communication system is provided, wherein the display is affected by the computed scores.

### TECHNICAL FIELD

The present disclosure relates to communication systems in general, and to scoring communication messages, in particular.

### BACKGROUND

Electronic-based communication message, such as e-mails, instant messages, Short Message Service (SMS) messages, Whatsapp™ messages, Facebook™ private messages, or the like, is a method of exchanging digital messages from an author to one or more recipients. E-mail is a prominent example of such communication system, which is referred to be herein as an example of a communication system.

Current mail systems are mostly client-server based. A mail server is an application that receives e-mail messages from e-mail clients, or from other mail servers. A mail server usually comprises a list of users, a storage area, a set of user definable rules, and a series of communication modules. The storage area is where received mail messages are stored for local users, and where messages in transit to another destination are temporarily stored. It usually takes the form of a database of information. The user defined rules determine how the mail server should react when determining the destination of a specific message, or possibly react to the sender of the message. For example: specific e-mail addresses can be barred, or certain users can be restricted to only sending messages within the company. The list of users is a database of user accounts that the mail server recognizes and will deal with locally, and the communications modules are components that actually handle the transfer of messages to and from other mail servers and e-mail clients. Depending upon the requirements of the mail server, a number of different modules may be installed and used by the server.

A mail client is an application, used by users for reading, writing, sending and receiving e-mail messages. A mail client may be installed on a user's computing platform, but may additionally or alternatively be implemented as a web page accessed for example using a browser. The client usually comprises an editor, an address book, a folder collection or hierarchy in which messages may be stored, and communications modules. The address book allows users to store commonly used e-mail addresses in an easy to get at format, reducing the chance of addressing errors.

In normal operation mode, a client composes a mail message addressed to one or more addressees. Zero, one or more of the addressees may be from the same organization, i.e., connected to the same mail server, and zero, one or more may be external to the organization. After composing the mail, it is being sent and distributed by the mail server to the internal addressees, if any, or to one or more external mail servers for distribution to the external addressees, if any.

Also in normal operation mode, a client receives e-mail messages from users within the organization or external to the organization. The user may view the received or sent mails, and may order them in accordance with predetermined parameters, such as receipt date and time, sender, subject, or the like. In some cases, computed parameter, such as “IS SPAM” parameter, or “IS IMPORTANT” parameter, may be computed when the e-mail is received and used for sorting or filtering of the e-mails.

### BRIEF SUMMARY

One exemplary embodiment of the disclosed subject matter is a computer program product comprising a non-transitory computer readable storage medium retaining program instructions, which program instructions when read by a processor, cause the processor to perform a method comprising: obtaining an external event, wherein the external event is external to a communication system through which a user received a plurality of communication messages; in response to the external event, computing scores to the plurality of communication messages, wherein each score is computed based on a relevancy measurement of a respective communication message to the external event; and provide a display of the communication system, wherein the display is affected by the computed scores.

Optionally, the display comprises ordering the plurality of communication messages based on the computed scores.

Optionally, the plurality of communication messages are a proper subset of communication messages received on behalf of the user and available for the user to view in the communication system.

Optionally, the method further comprises: computing a first set of scores for each of the plurality of communication messages, wherein said computing is performed prior to said obtaining the external event; whereby re-scoring the plurality of communication messages based on the external event.

Optionally, having a communication message having a first score prior to said obtaining the external event; wherein said computing scores comprises computing a second score for the communication message using the second score, wherein said computing the second score comprises applying an adjustment parameter to the first score, wherein the adjustment parameter is affected by a relevancy measurement of the external event to the communication message.

Optionally, said computing scores comprises applying a trained prediction model to predict scores, wherein the trained prediction model is configured to receive a feature vector for prediction, wherein the feature vector comprising at least a feature representing the external event.

Optionally, the feature vector comprises a plurality of features, each of which representing a different external event.

Optionally, for each different external event, the feature vector comprises a first feature representing time elapsed since the external event and a second feature representing the relevancy measurement of the external event.

Optionally, said obtaining the external event comprises obtaining contextual information about the user from a computer program used by the user.

Optionally, the computer program is a web browser, wherein the contextual information comprises an identification of a currently visited web page.

Optionally, said obtaining the external event comprises obtaining information from a user-associated device located in physical proximity to the user.

Optionally, said obtaining the external event comprises obtaining recorded audio or recorded video in vicinity of the user.

Optionally, said obtaining the external event comprises obtaining information from a data source accessible via a computerized network.

Optionally, said obtaining the external event comprises obtaining information from an intranet associated with an organization, wherein the communication system is a communication system of the organization, wherein the user is part of the organization.

Optionally, said obtaining the external event comprises obtaining news items from an online news source.

Optionally, said obtaining the external event comprises obtaining information from a location-based service, wherein the location-based service is configured to provide information relating to a location of the user.

Optionally, said obtaining the external event comprises determining user activity based on recorded physical measurements of the user.

Optionally, the plurality of communication messages are selected from a group consisting of: e-mail messages, instant messages, Short Message Service (SMS) messages, and private messages in a social network platform.

Optionally, the display comprises an explanation indicating to the user that the external event caused a modification in a score of a communication message.

Another exemplary embodiment of the disclosed subject matter is a computerized apparatus having a processor, the processor being adapted to perform the steps of: obtaining an external event, wherein the external event is external to a communication system through which a user received a plurality of communication messages; in response to the external event, computing scores to the plurality of communication messages, wherein each score is computed based on a relevancy measurement of a respective communication message to the external event; and provide a display of the communication system, wherein the display is affected by the computed scores.

Yet another exemplary embodiment of the disclosed subject matter is a computer program product comprising a computer readable storage medium retaining program instructions, which program instructions when read by a processor, cause the processor to perform a method comprising: obtaining an external event, wherein the external event is external to a communication system through which a user received a plurality of communication messages; in response to the external event, computing scores to the plurality of communication messages, wherein each score is computed based on a relevancy measurement of a respective communication message to the external event; and provide a display of the communication system, wherein the display is affected by the computed scores.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2A-2E show flowchart diagrams of methods of obtaining external events, in accordance with some exemplary embodiments of the disclosed subject matter;

FIG. 3A-3B show flowchart diagrams of methods of computing new scores, in accordance with some exemplary embodiments of the disclosed subject matter;

FIG. 4 shows a schematic block diagram of a system, in accordance with some exemplary embodiments of the disclosed subject matter; and

FIG. 5 shows a flowchart diagram of a method, in accordance with some exemplary embodiments of the disclosed subject matter.

### DETAILED DESCRIPTION

In the description below, the terms “mail”, “e-mail”, “email”, “message”, “communication” or “communication message” are used interchangeably and refers to an electronic communication message that may be transmitted by an author to one or more intended recipients and may be consequently received by devices of such recipients. The term should be construed to exclude broadcasted messages, such as posts in a bulletin board, posts in a social network, or the like, which are not designated to a specific user or group of users, and which can be viewed by users who the message was not originally intended to. The term is not limited to any specific protocol. Exemplary protocols for transmitting such messages may include Simple Mail Transfer Protocol (SMTP), Post Office Protocol (POP3), Internet Message Access Protocol (IMAP), Short Message Service (SMS) or the like.

One technical problem dealt with by the disclosed subject matter is the limited control users have over the incoming communication messages they are receiving. Incoming communication messages are usually sorted in accordance with one of a few predetermined and technical parameters, such as receiving time, sender, subject, or the like. However, these arrangements seldom reflect the real importance and priority of a mail message to the receiver, and are static.

It may be desired to provide a score-based system in which each communication message is given a dynamic score which may change over time in view of external events. In the present disclosure, an event is deemed as “external event” if the event is external to the communication system itself. External events may include events that are reported by news sites, social media networks, or the like. In some cases, only external events in a geographic proximity of the user may be processed, such as by filtering events based on their geolocation and using location-based services to identify a location of the user. Additionally or alternatively, external events may include user-centric events, such as an activity the user is performing, health events of the user, viewing of objects by the user, the user hearing someone speak, the user speaking herself, or the like. Additionally or alternatively, external events may be events occurring in the real, non-digital, world.

When an external event is identified, it may be desired to modify the communication system to reflect the things that may be of increased importance in view of the event. It will be appreciated that the importance and priority may be required to be dynamic, i.e., may change over time, as a result of the external events.

The present disclosure makes use of an example of an external event, in which a startup company completed an investment round. Such an event may raise the interest of the user in communication messages relating to the startup company, such as if the user is a service provider of the startup company. Such an event may increase the interest of the user in communication messages relating to funds, if the user is part of the startup company. As another example, such an event may decrease the interest of the user in the startup company if the user is a potential investor.

One technical solution relates to automatically identifying an external event. In response to the automatic identification of the external events, re-scoring is performed so as to modify at least one previously-computed score of communication messages. Communication messages may be scored to indicate priority, importance, urgency, or the like. A User Interface (UI) of the communication system may be configured to utilize the scores to define a relative order between the communication messages. Once re-scoring is performed, the relative order between the communication messages may be changed.

In some exemplary embodiments, a relevancy score, also referred to as a relevancy measurement, of the event to the communication message may be computed. The relevancy score may be computed using search-based methods, which attempt to identify relevant results to a query. The event may be viewed as the query and the communication messages—as the corpus in which the search is performed. Different methods that are employed by search engines may be utilized for this purpose, such as concept search, semantic search, or the like. The event may be assigned tags based on the content thereof, such as using dictionaries, ontologies, or the like. In some exemplary embodiments, co-occurrence statistics may be employed to determine relevancy. Additionally or alternatively, Natural Language Processing (NLP) techniques may be employed to process the event and determine relevancy to communication messages. Additionally or alternatively, deep learning techniques, such as Artificial neural networks (ANNs), deep neural networks (DNNs), or the like.

In some exemplary embodiments, in order for the relevancy score to be computed, a textual representation of the event may be computed. The textual representation may be extracted directly from the event, such as a text of a published news article, a text of a web page, text extracted from speech using text to speech methods, or the like. Additionally or alternatively, metadata of the event may be translated into text as well, such as location, geotags, time thereof, or the like. In some exemplary embodiments, the event may have a label, such as in case of activity tracking, where the label may indicate the detected activity (e.g., parking event, driving event, purchasing event). The label may be used as the text of the event or portion thereof.

In some exemplary embodiments, the re-scoring may be performed with respect to a proper subset of the communication messages. In some cases, only communication messages that are relevant to the event may be re-scored. In some exemplary embodiments, based on the relevancy score, it may be determined which portion of the communication messages is relevant to the event and which is irrelevant thereto, such as based on a predetermined absolute or relative threshold. The relevant portion may be re-scored.

In some exemplary embodiments, the re-scoring may be performed using the relevancy score. Additionally or alternatively, the re-scoring may be performed based on a time elapsed since the event occurred, to provide for a decaying effect of events on scoring. In some cases, the score may be relatively higher for communication messages for which the event is relevant, when the event had just occurred as opposed to after a significant time elapsed. Each event may have a different decaying effect as some events may be momentarily while others may remain relevant for longer period of time. For example, an event announcing a funding round for a company may be relevant for days or even weeks, while an event relating to a party may be relevant for hours as the party is held.

In some exemplary embodiments, the score may be adjusted using an adjustment parameter which is affected by relevancy score. The re-scoring is performed by taking a previously computed score of the communication message and modifying it based on an adjustment constant that is manipulated based on the relevancy score to provide increased modification effect when the relevancy score is highest. As an example, re-scoring may be performed by computing s_{new}=s_{old}+adj(r), where s_{new} is the new score, s_{old}, is the previously computed score, r is the relevancy score and adj( ) is an adjustment parameter. Additionally or alternatively, re-scoring may be performed by computing s_{new}=s_{old}·adj(r). Additionally or alternatively, the adjustment parameter may be, for example, adj(r)=c^{r}, where c is a positive constant and r is between 0 and 1. In some cases, the adjustment parameter may be affected by a time elapsed since the event occurred, denoted by t (e.g., adj(r, t)). In some cases, the originally computed score may be computed using a different method, such as using a prediction model trained using machine learning methods, to predict a score. The prediction model may be trained based on the data of the user, thereby providing a personalized score prediction. The prediction model may be a regression-based techniques, Support Vector Machines (SVM), decision tree learning, or the like. The score may then be adjusted based on the event, avoiding the need to re-employ the prediction model, and as a result, provide the re-score using a reduced amount of computation resources.

In some exemplary embodiments, a prediction model may be used to determine a score of a communication message. Features may be defined based on the communication messages, such as features representing the content of the communication message, features representing users associated with the communication message (e.g., author, destination, carbon-copied recipients, etc.), features representing metadata of the communication message (e.g., transmission time, receipt time, user-defined priority, protocol, format, or the like), or the like. In some exemplary embodiments, one or more features may be used to encode relationship to events. As an example, features r₁ . . . rₙ may represent relevancy score of n last events, representing a sliding window of up-to n events. In some exemplary embodiments, features t₁ . . . tₙ to may be used to indicate a time since each event represented by a corresponding relevancy score. Using such feature encoding, the prediction model itself may take into account the recent events and their relevancy to each communication message in determining the score of the communication message. In such an embodiment, a potentially more accurate prediction may be provided using relatively more extensive computational resources than a simple adjustment. In such an embodiment, re-scoring may be performed without using the previously computed score. Instead, new valuations of the features (namely features r₁ . . . rₙ and t₁ . . . tₙ) may be computed, and the prediction model may be employed without being informed of the previous score. Additionally or alternatively, an additional feature may encode the previous score to enable the prediction model to modify the scoring in a manner that does take into account the previously computed score.

The external event may be obtained from various sources. External events may be obtained from the Internet, an intranet (e.g., organizational portal, organizational network, or the like). As an example, a server may listen on RSS (Really Simple Syndication) feeds, monitor pre-determined URLs, register on alerts, or the like, to receive new external events as they are created. In some exemplary embodiments, web pages, HTML pages, XML files, or the like may be obtained and the content thereof may be the content of the external event. Additionally or alternatively, predetermined data sources, such as a weather service, may be utilized to receive events and events update, such as current weather condition, weather forecast, or the like.

In some exemplary embodiments, location based services may be employed to obtain events that are relevant to a current physical location of the user. A GPS receiver, a location module, or the like, may be used to determine a location of the user. External events may have a geo-location, such as an address, coordinates, or the like. External events in the vicinity of the user may be processed, while events far away may be ignored, thereby providing a localized effect. As an example, if the startup company is a company in China, and the user is located in China, the event may be of interest, while the event may be of no interest if the user is located in the USA.

In some exemplary embodiments, wearable sensors may be used to obtain the event. In some exemplary embodiments, the event may be detected using a sensor measuring a physical measurement relating to the user or her surrounding, such as a biometric sensor sensing biometric feature of the user (e.g., pulse sensor), movement sensors such as an accelerometer, for measuring measurements relating to the movement of the user, microphone for capturing audio which can be translated into text using speech recognition, video camera for obtaining images that can be processed by a computer vision algorithm for analysis, or the like. Sensors integrated into Augmented Reality (AR) devices may be utilized for capturing the events. Additionally or alternatively, smart speakers, such as speakers with an integrated virtual assistant, may be used to capture audio signal in the proximity of the user, such as conversation in which the user speaks, conversation in which someone speaks to the user, or the like.

In some exemplary embodiments, events may be obtained from another software that is not part of the communication system. As an example, a browser being used by the user may report a current URL being visited by the user, a current web page being viewed by the user, or the like. Such content may be viewed as a potential source of an event. In some exemplary embodiments, the page may be analyzed to detect region of interest therein, and based on the region of interest an event may be generated.

One technical effect of the disclosure relates to an improved prioritization of communication messages based on events that are external to the communication system. Improved prioritization that may depend on the context of the user, and based on events that influence the user, such as in view of their location, proximity to the user, relation to the user, or the like.

Another technical effect may include improved accuracy using increased resources, using a predictive model.

Yet another technical effect may include re-scoring using a reduced resources, by adjusting existing scores instead of re-computation thereof.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

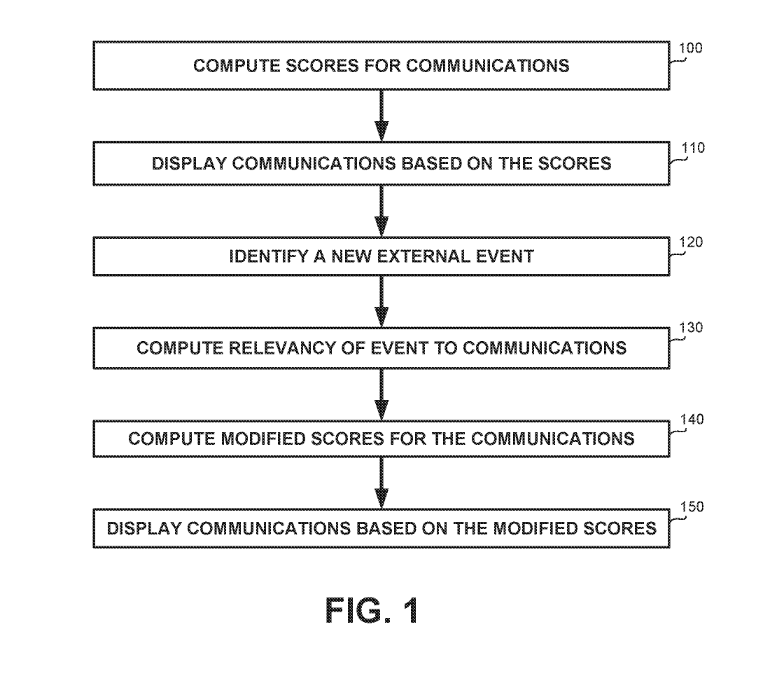

Referring now to FIG. 1, showing a flowchart diagram of a method for performing re-scoring, in accordance with some embodiments of the disclosed subject matter.

On Step 100, a communication system retaining a plurality of communication messages of a user, computes a score for each communication message. The score may be computed using a prediction model, such as a machine learning classifier or using regression-based techniques, such as by encoding the communication message and data relating thereto into features to create an instance. The instance may be represented by a feature vector. The instance may be provided to the prediction model to predict a score. Additionally or alternatively, scoring may be performed by applying an explicit mathematical formula. Additionally or alternatively, the scoring may be performed in a personalized manner, such as by employing a prediction model that is trained based on user data. In some cases, the score may indicate importance of a communication message. Additionally or alternatively, the score may indicate a sorting order of the communication message.

In some exemplary embodiments, the score may be computed when the communication message is first obtained. For example, when an e-mail is received in a user's inbox, it may be scored. In some cases, the communication message may be re-scored on future occurrences, such as when an external event is identified. Additionally or alternatively, the communication message may be scored first when the score is to be used. For example, the score may be computed when the user opens her inbox to view the communication messages. Communication messages that were not scored before may be scored on-demand, and the past scores of the other communication messages may be used as is or alternatively, be re-computed.

On Step 110, a Graphical User Interface (GUI) of the communications system may be used to display the communication messages. The manner of display may be affected by the score of the communication messages, such as for example, displaying only messages having a score above a minimal threshold, emphasizing communication messages having a score above a threshold, ordering the communication messages based on their scores, or the like. In some cases, a sound cue may be provided based on predetermined rules, such as if there exists a communication message above a threshold.

On Step 120, a new external event is identified. The new external event may be identified and obtained from a myriad of different sources. In some exemplary embodiments, the external event may be identified from the Internet, an organizational portal, an organizational intranet, or other corpus of unstructured data. In some exemplary embodiments, the corpus may be monitored, such as by employing period search queries, for relevant keyword. Additionally or alternatively, each update to the corpus, such as insertion of new document and updating of existing document, may be monitored and referred to as a potential new external event. Additionally or alternatively, a stream of documents, such as an RSS feed, a news feed, or the like, may be listed on for identifying new documents that serve as a basis of an external event.

Documents may be analyzed, such as using NLP techniques to identify topics thereof, objects mentioned therein, or the like. In some exemplary embodiments, the NLP analysis may be performed with respect to the user, such as to determine relevancy of the document to the user, such as based on the document comprising content that is likely of relevancy or interest to the user. In some cases, relevancy may be determined based on the communication messages in the inbox of the user, communication messages the user received in a recent timeframe (e.g., last week), or the like. Relevancy may be determined with respect to communication messages that may be re-scored based on the potential event. In some exemplary embodiments, the user's activity may be monitored to extract topics of interest, such as based on actions made by the user, content received by her, content written by her, content ignored by her, actions performed externally to the communication system, browsed web pages, activity history, or the like. In some exemplary embodiments, a myriad of keywords may be associated with the user, indicating topics of interest, each of which may be associated with an importance score indicating importance of the topic to the user. The keywords may be used to obtain the documents, such as by employing a search query based on the keywords to obtain the documents from the corpus, or to filter obtained documents using such keywords.

Additionally or alternatively, location-based services may be employed to obtain documents that are associated with the user, as a basis for an event. In some exemplary embodiments, location-based services may be used to obtain location-based data, such as weather condition, traffic condition, news events, or the like, in the proximity of the user. In some exemplary embodiments, location-based data may be obtained based on a location of the user, which may be tracked using location sensors, such as GPS in a mobile phone thereof, cellular triangulation, or the like.

Additionally or alternatively, events may be obtained based on sensors in wearable devices of the user or other user-associated devices, such as mobile phones thereof. Sensors may include microphones capturing speech, such as a verbal statement by the user, a verbal statement directed at the user, a verbal statement in the vicinity of the user, or the like. Conversations around the user may be the basis of new events. Additionally or alternatively, the sensor may be a camera obtaining images that can be processed to identify events in the vicinity of the user. The images may be processed using computer vision techniques to identify objects therein, which may be used as the basis of defining an event. Additionally or alternatively, the sensors may include biometric sensors sensing a biometric feature of the user (e.g., blood rate, heart rate). Biometric features may be used as the basis of biometric events, such as a health episode (e.g., a stroke), physiological context (e.g., relaxed), or the like. Biometric events may be identified automatically, such as for example using a classifier that is trained using a labeled training dataset. Additionally or alternatively, the sensors may be movement sensors, accelerometers, or the like, from which the activity of the user may be inferred, such as riding a bike, driving, walking, playing a video game, or the like. The activity may be detected using a classifier that is trained using a labeled training dataset.

In some exemplary embodiments, the event may be created based on a textual representation of the information obtained from the sensors, such as a label of the activity or physical condition, as identified by a classifier, a text representing an image, a textual representation of conversation, or the like.

On Step 130, a relevancy of the event to the communications may be computed. In some cases, the relevancy may be computed on Step 120 as part of the identification of the event itself. In other cases, the relevancy may be computed posteriori to the identification of the event. A relevancy score may be computed using search-based methods, such as employed in search engines for identifying a relevancy of a document to a query. The communication message may viewed as the document and the event—the query. In some cases, the event may be represented by a textual string, an image, a combination thereof, or the like, and may be compared with the communication messages to determine the relevancy score. In some cases, relevancy of text may be determined using abstraction methods, topic summarization, ontologies, inter-dependency of keyword pairs or other statistical measurements relating to pairs of words, or the like.

On Step 140, a modified score for the communication messages may be computed. In some cases, all communication messages may be re-scored. Additionally or alternatively, a portion of the communication messages may be re-scored, such as unread communication messages, communication messages received in a recent timeframe, communication messages appearing in a view of the inbox, combination thereof, or the like. Additionally or alternatively, communication messages having a relevancy score above a threshold may be re-scored.

The new score may be computed using the previously computed score modified based on an adjustment parameter. The adjustment parameter may be affected by the relevancy score, thereby modifying the score based on the relevancy of the event. Additionally or alternatively, the adjustment parameter may be affected by the time elapsed since the event occurred, thereby providing for a decaying effect.

Additionally or alternatively, the new score may be computed without directly being based on the previous score. In some embodiments, a prediction model may be trained to determine a score. The user may provide feedback on previous scores to indicate to improve future predictions such as by manually verifying or refuting the score. It will be noted that user feedback may be implicit, such as monitoring activity of the user to infer whether the score was correct for the user. As an example, user viewing the communication message and time elapsed since the communication message was shown to the user and the user had viewed it, may be indicative of the subjective score the user has given the communication message. As another example, the activity of the user after being exposed to the communication message, such as her emotional reaction (which may be tracked by tracking bio-measurements such as Pupillary response), her actions within the communication system (e.g., responding to the communication message or sending another communication message relating thereto), her actions outside the communication system (e.g., browsing activities after viewing the communication message), or the like, may also be used to infer whether the score was correct. The prediction model may be re-trained using additional data as its training dataset to improve its prediction capabilities. The communication message may be encoded into features to define an unlabeled instance that is scored by the prediction model. The features may include features representing the content of the communication message (e.g., top appearing words, words in title, or the like), metadata of the communication message (e.g., transmission time, flags' values, permissions, message routing information, header information, author, recipients, relationships therebetween and between the user, or the like), or the like. The features may include features relating to the event (or sequence of most recent events), such as keywords of the event, relevancy score of the event to the communication message, or the like.

On Step 150, the communication messages may be displayed, such as in the GUI, based on the modified scores computed on Step 140. The GUI may reorder the communication messages based on the modified scores, may hide communication messages having modified score below a threshold, display in an emphasized manner communication messages having a high score, or the like. In some exemplary embodiments, the display may provide an emphasis to visually display to the user that a score of communication message has changed drastically, such as become very important. In some cases, only positive drastic changes are emphasized. A drastic change may be determined based on the absolute score being above a first threshold and the proportional change being above a second threshold. For example, a change that changes the score to above 70%, and which changes the score by 20% or more may be considered drastic change to be visually indicated to the user. However, other configurations may be used and the parameters may be set after experimentations to identify the optimal configuration.

In some exemplary embodiments, the user may request a feedback indicating what caused the re-scoring. In such a case, an explanation including a summary of the event may be presented to the user with relation to the communication message. In one exemplary embodiment, upon re-scoring, if a score of a communication message is increased significantly, the communication message may be displayed together with a “tip” icon. If the user interacts with the icon, such as by clicking it, hovering over it with a pointer, or the like, the reason for re-scoring may be displayed. The explanation may include a summary of the event, such as created using automatic summarization methods, based on templates, or the like. In some exemplary embodiments, the summary may be linked to a detailed explanation about the event, such as linked to a URL of the news item, linked to a page showing browser context, linked to a complete text of an identified speech that was used as a basis of the event, or the like. In some cases, more than one event may have caused the change in the score, and a list of all relevant events may be provided to the user. It will be noted that an explanation may be provided regarding all communication messages, and not only to those whose new score has increased significantly.

In some exemplary embodiments, the explanation may include indications of reasons which caused the scoring, even if no re-scoring has occurred. For example, the explanation may indicate: “important sender” to explain a high score because of the identity of the sender, or “subject you are interested in” to explain a high score due to the subject of the communication message. As another example, a low score can be explained as being due to “duplicate content”, “task that you have already performed”, “you deleted similar messages”, “unimportant sender”, or the like.

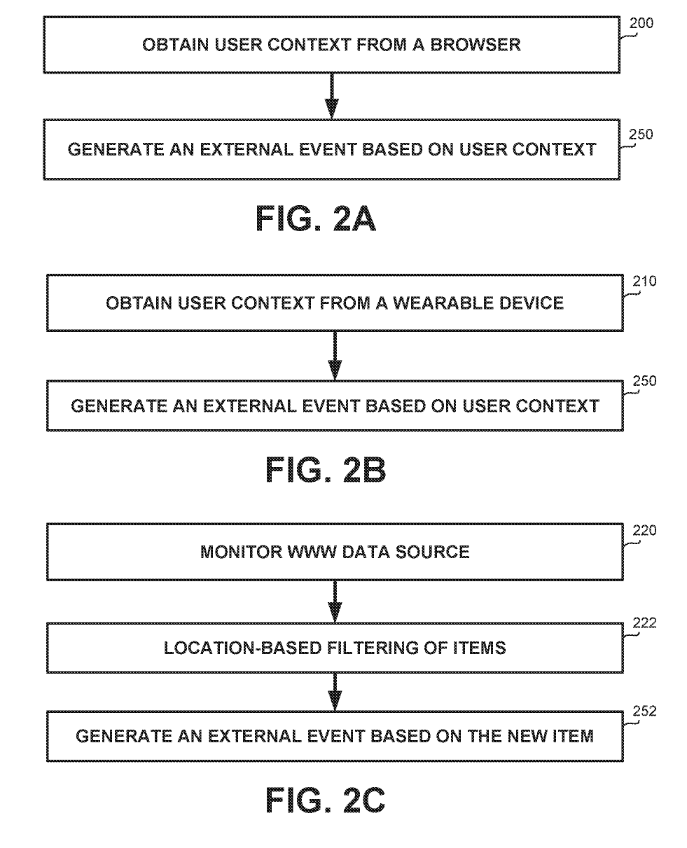

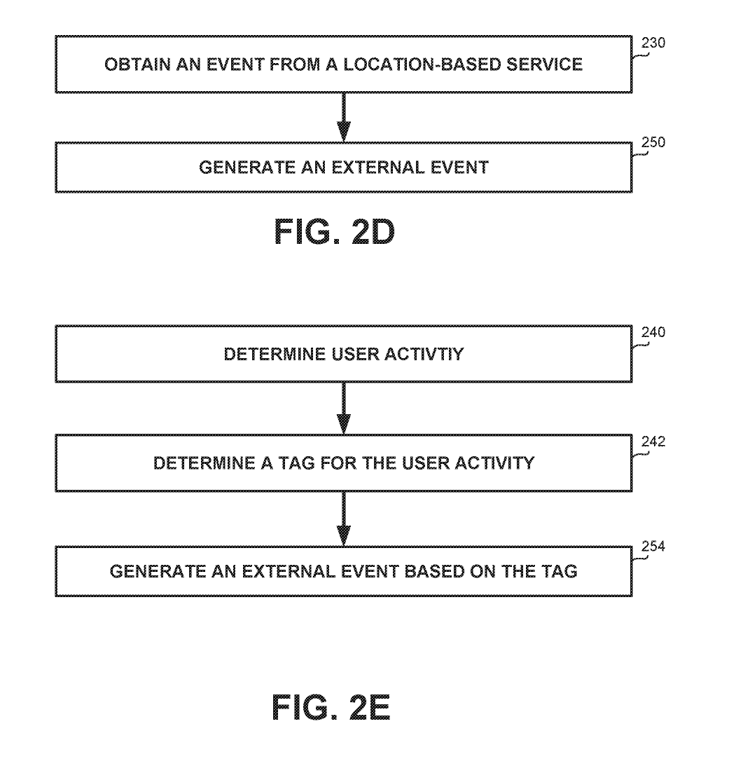

Referring now to FIGS. 2A-2E showing flowchart diagrams of methods for obtaining an external event, in accordance with some embodiments of the disclosed subject matter.

On Step 200, a user context may be obtained from an application that is being used by the user. The application may be an application external to the communication system (e.g., not an e-mail client), such as a web browser, a game app, or the like. The user context may be a URL address which the user is currently visiting. The user context may be an action performed by the user using the application.

On Step 250, an external event is generated based on the user context. As an example, if the user context is a web page, the page may be processed to generate the external event. It is noted that in FIG. 2C described below, web pages that were not actually viewed by the user may serve as the basis of an event to impact the scores of her communication messages. This is as opposed to the web pages of FIG. 2A, which are pages visited by the user.

On Step 210 of FIG. 2B, a user context is obtained based on a wearable device. The wearable device, such as a health tracker, AR glasses, or other user-devices that the user carries with her, or that monitor the user, such as smart speakers (e.g., ECHO™ and AMAZON ALEXA™), mobile phones, or the like, may be used to determine current activity of the user, conversation heard by the user, speech of the user, sites viewed by the user or appearing in her vicinity, or the like. In some cases, the context is directly obtained from the device without additional processing. Additionally or alternatively, the context may be obtained by processing crude data, such as performing computer vision processing, speech to text, NLP techniques, classification and label prediction, or the like.

On Step 220 of FIG. 2C, a corpus of documents, such as the World Wide Web (WWW), an intranet, the Internet, or the like, may be monitored. As an example, an online news outlet may be monitored for news events, a patent database may be monitored for published applications and issued patents, or the like. Monitoring may be implemented in a push manner, where triggers alert the system of the existence of a relevant item (e.g., GOOGLE™ alerts, listening on a URL or a feed, or the like), or in a pooling manner, where the system actively queries the corpus, such as by re-invoking search engines thereon.

On Step 222, the items may be filtered based on a user location. In some cases, items may have a geo-location which may be compared to the location of the user. As an example, local news item may be considered as an event only in the same city, while national news item may be considered as an event in the same country but not in foreign countries. The location of the user may be tracked using a location sensor, using location services, or the like.

On Step 252, an external event is generated based on the item. In some cases, a plurality of events may be created from a single item. As an example, consider a homepage of a news site. Such page may comprise a plurality of different sections, each of which corresponding to a potential separate event.

On Step 230 of FIG. 2D, an event may be obtained from a location-based service. Location-based information may include information relating to a current location of the user. For example, the location-based service may provide current weather in the current location of the user, a change in weather in the current location of the user, a traffic jam in the current location of the user, or the like.

On Step 240 of FIG. 2E, user's activity may be determined, such as by tracking the user's movement using wearable devices and other IoT devices. In some cases, the activity may be tracked using user devices such as a mobile phone carried by the user.

On Step 242, a tag representing the user's activity, such as the title of the activity (e.g., driving a car, playing XBOX™, watching a movie, attending a meeting, or the like) may be determined. The tag of the activity may be used as the textual representation thereof, which may be the content of the external event (Step 254). The external event may comprise the tag, and such textual representation may be used to determine relevancy of the event to communication messages. In some cases, in addition to the textual tag or instead thereof, an image may be used to represent the activity, such as an image of the user performing the activity. The event may be based on products of a processing of the image.

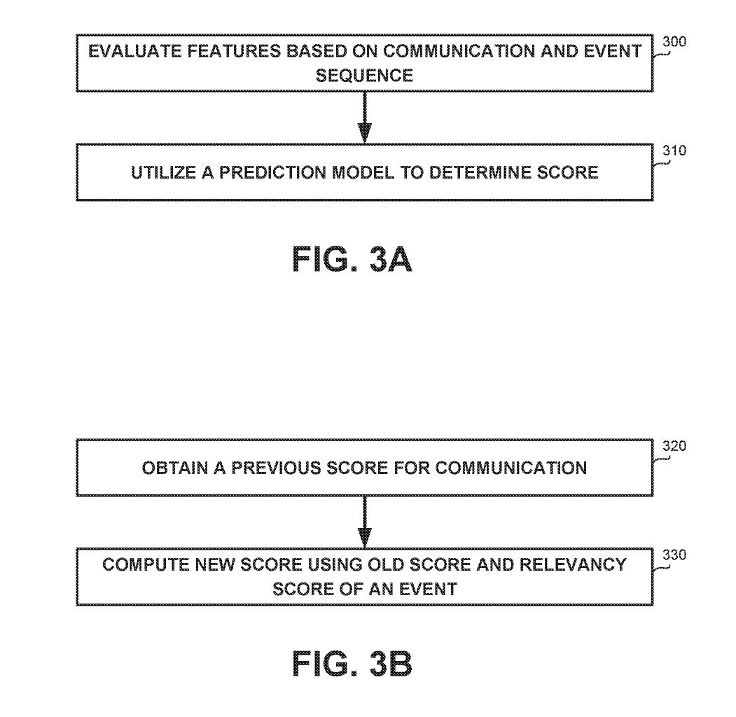

Referring now to FIG. 3A, showing a flowchart diagram of a method for performing re-scoring, in accordance with some embodiments of the disclosed subject matter.

On Step 300, features of an instance are determined. The value of each feature may be based on the communication message, content thereof, metadata thereof, or the like. The value of at least one feature may be based on an event, such as a relevancy score of the event. In some cases, a plurality of features may be used to represent a sequence of events, each of which is represented by a different one or more features. In some cases, each event may be represented by a relevancy score and an elapsed time since the event has occurred.

On Step 310, a predictor tool may employ a prediction model to determine the score based on the instance. The prediction model may be trained using a training dataset. In some cases, the training dataset may be user-centric, may be updated based on user feedback, or the like.

In some exemplary embodiments, a classification algorithm, such as decision tree learning, SVMs, or the like, may be used to train the prediction model. Additionally or alternatively, the prediction may be performed using regression-based techniques to provide each communication message a continuous score. As an example, each communication message may be represented by a feature vector X̅=(X₁ . . . Xₙ). A function ƒ( ) may be utilized to determine the score of the communication message using weights w₁ . . . wₙ. For example, the function may be

$$f ( \overline{X} ) = {\sum }_{i = 1}^{n} {X}_{i} \cdot {w}_{i} .$$

When the value of any of the features is changed, such as in view of an event occurring, the function ƒ( ) may be employed to re-calculate the score for the communication message. The values of the weights may be determined based on the training data and may be re-estimated periodically, such as every hour, day, week, month, or the like. Upon re-estimation of the weights, all scores may be re-computed based on the new regression model.

Referring now to FIG. 3B, showing a flowchart diagram of a method for performing re-scoring, in accordance with some embodiments of the disclosed subject matter.

A previous score of a communication message may be obtained (Step 320) and utilized to compute the new score (Step 330). The new score may be an adjustment of the old score in view of the relevancy of the new event. In some cases, repetitive updates may be performed using the original score and using an adjustment parameter that depends on elapsed time since the event occurred. Additionally or alternatively, repetitive updates may be performed using last computed score that is incrementally updated. In incremental updates, a decaying effect may be achieved by reducing the previously computed score in view of the time elapsed since the previous event occurred, since the previous computation was performed, since the original computation was performed, or the like. In some cases, the original score may be computed using a trained classifier.

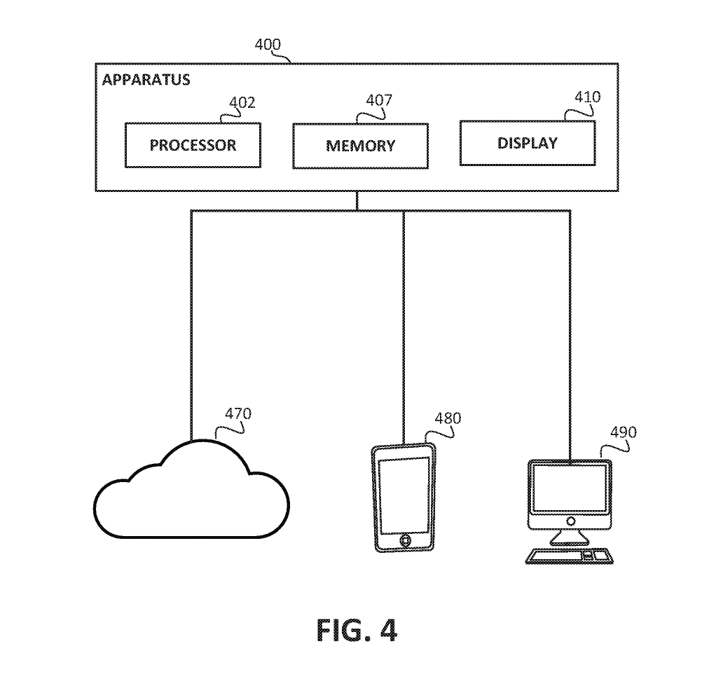

Referring now to FIG. 4 showing a schematic block diagram of a system, in accordance with some exemplary embodiments of the disclosed subject matter.

In some exemplary embodiments, the disclosed subject matter may be implemented using Apparatus 400, which may be any computing platform, such as a server, a desktop computer, a mobile computer, a cluster of computers, or the like.

Apparatus 400 may comprise one or more processor(s) 402. Processor 402 may be a Central Processing Unit (CPU), a microprocessor, an electronic circuit, an Integrated Circuit (IC) or the like. Processor 402 may be utilized to perform computations required by the Apparatus 400 or any of it subcomponents.

In some exemplary embodiments of the disclosed subject matter, Apparatus 400 may comprise a Display 410. Display 410 may be utilized to provide output to a user. Display 410 may be used to display the communication messages, indication of scores thereof, or the like. In some cases, the communication messages may be ordered in accordance with their scores and the order may be changed upon a re-scoring. In some cases, additional I/O devices (not shown) may be utilized such as communication module, a pointing device, a keyboard, a touch screen, or the like. The I/O devices, together with Display 410, may be used to allow the user to interact with Apparatus 400; to obtain information from external devices such as via a computerized network, from peripheral devices, or the like; display to the user communication messages and enable the user to view them and act upon them; display to the user information about external events associated with the communication messages such as events that caused a message to be re-scored or changed a score in a relatively significant manner; or the like.

In some exemplary embodiments, Apparatus 400 may comprise a Memory 407. Memory 407 may be a hard disk drive, a Flash disk, a Random Access Memory (RAM), a memory chip, or the like. In some exemplary embodiments, Memory 407 may retain program code operative to cause the Processor 402 to perform acts to implement any of the steps disclosed above. In some cases, components may be implemented as one or more sets of interrelated computer instructions, executed for example by Processor 402 or by another processor. The components may be arranged as one or more executable files, dynamic libraries, static libraries, methods, functions, services, or the like, programmed in any programming language and under any computing environment. Memory 407 may retain communication messages, computed scores, or the like.

In some exemplary embodiments, Apparatus 400 may obtain information useful for defining an external event from various sources. In some exemplary embodiments, a browser executed on Apparatus 400 may indicate a current URL the user is currently accessing. In some cases, the browser may report the information to an external server which may report the URL to Apparatus 400 regardless of whether the user is using Apparatus 400 for browsing purposes, or another device, such as Mobile Device 480, Computer 490, or the like. In some cases, computing the scores may be performed by an on-device client or by a server connected to an on-device client. The scores may be used by the on-device client to determine a presentation based thereof. In some cases, Online Service 470 may be used in defining the external events. Online Service 470 may be a data feed that is monitored and which provides information such as news articles, weather information, or the like.

Additionally or alternatively, events may be created based on user-associated devices, such as Mobile Device 480, wearable device (not shown), or the like. The user-associated device may be used to determine a current activity of the user, and based thereon, external events may be determined.

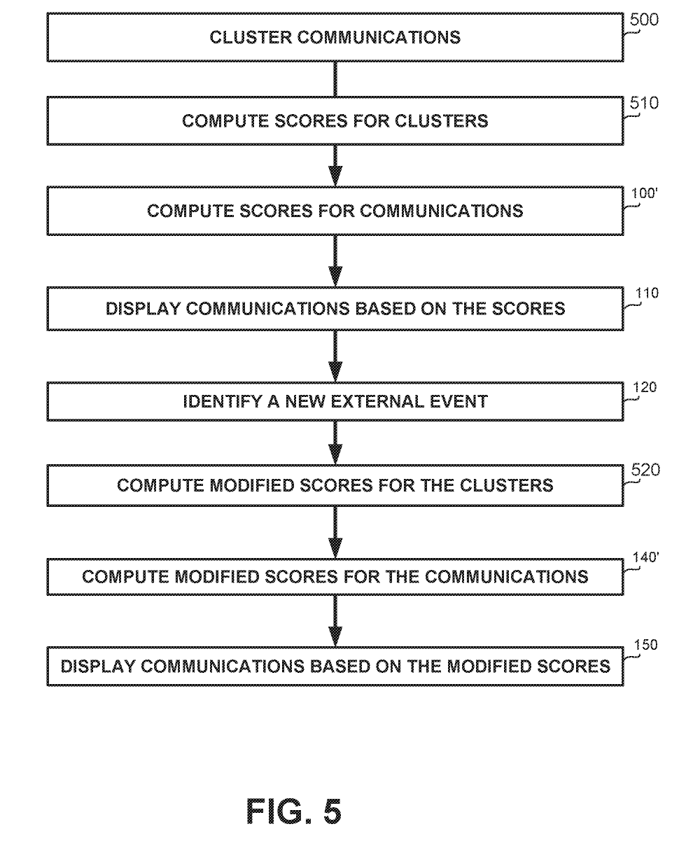

Referring now to FIG. 5 showing a flowchart diagram of a method, in accordance with some exemplary embodiments of the disclosed subject matter.

On Step 500, communications may be grouped into clusters. In order to cluster the communication messages, each communication message may be assigned a feature vector. The feature vector may comprise features representing properties of the communication message, such as metadata, content, or the like. As an example, NLP techniques, such as bag of words, may be used to process the communication message to obtain the properties. Based on the feature vectors, clusters may be determined using clustering algorithm.

On Step 510, each cluster may be provided a score. The score may be a score representing priority, urgency, interest, or the like, in communication messages in the cluster. In some cases, the score may be determined in a similar manner to the determination of a score of a single communication message, such as using a regression model, using a predictive model that is a-priori trained, or the like.

On Step 100′, a score for a single communication message may be computed. The score may be determined similarly to the score computation of Step 100 of FIG. 1. In some exemplary embodiments, the score of the communication message may be based also on the score of the cluster. For example, the score may be computed as a function of score(m)·w+score(c)·(1−w), where score(m) is the score of the communication message without taking into account the score of the cluster, score(c) is the score of cluster c which comprises communication message m, and w is a number between zero and one.

After a new external event is identified, Step 520 may be performed. On Step 520, the clusters may be re-scored similarly to the re-scoring of communication messages discussed above. Using the modified score of the clusters, the communication messages may be re-scored as well (Step 140′).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer program product comprising a non-transitory computer readable storage medium retaining program instructions, which program instructions when read by a processor, cause the processor to perform a method comprising:
obtaining an external event, wherein the external event is external to a communication system through which a user received a plurality of communication messages;
in response to the external event, computing scores to the plurality of communication messages, wherein each score is computed based on a relevancy measurement of a respective communication message to the external event; and
provide a display of the communication system, wherein the display is affected by the computed scores.

2. The computer program product of claim 1, wherein the display comprises ordering the plurality of communication messages based on the computed scores.

3. The computer program product of claim 1, wherein the plurality of communication messages are a proper subset of communication messages received on behalf of the user and available for the user to view in the communication system.

4. The computer program product of claim 1, wherein the method further comprises:
computing a first set of scores for each of the plurality of communication messages, wherein said computing is performed prior to said obtaining the external event;
whereby re-scoring the plurality of communication messages based on the external event.

5. The computer program product of claim 1, wherein:
having a communication message having a first score prior to said obtaining the external event;
wherein said computing scores comprises computing a second score for the communication message using the second score, wherein said computing the second score comprises applying an adjustment parameter to the first score, wherein the adjustment parameter is affected by a relevancy measurement of the external event to the communication message.

6. The computer program product of claim 1, wherein said computing scores comprises applying a trained prediction model to predict scores, wherein the trained prediction model is configured to receive a feature vector for prediction, wherein the feature vector comprising at least a feature representing the external event.

7. The computer program product of claim 6, wherein the feature vector comprises a plurality of features, each of which representing a different external event.

8. The computer program product of claim 7, wherein for each different external event, the feature vector comprises a first feature representing time elapsed since the external event and a second feature representing the relevancy measurement of the external event.

9. The computer program product of claim 1, wherein said obtaining the external event comprises obtaining contextual information about the user from a computer program used by the user.

10. The computer program product of claim 9, wherein the computer program is a web browser, wherein the contextual information comprises an identification of a currently visited web page.

11. The computer program product of claim 1, wherein said obtaining the external event comprises obtaining information from a user-associated device located in physical proximity to the user.

12. The computer program product of claim 1, wherein said obtaining the external event comprises obtaining recorded audio or recorded video in vicinity of the user.

13. The computer program product of claim 1, wherein said obtaining the external event comprises obtaining information from a data source accessible via a computerized network.

14. The computer program product of claim 1, wherein said obtaining the external event comprises obtaining information from an intranet associated with an organization, wherein the communication system is a communication system of the organization, wherein the user is part of the organization.

15. The computer program product of claim 1, wherein said obtaining the external event comprises obtaining news items from an online news source.

16. The computer program product of claim 1, wherein said obtaining the external event comprises obtaining information from a location-based service, wherein the location-based service is configured to provide information relating to a location of the user.

17. The computer program product of claim 1, wherein said obtaining the external event comprises determining user activity based on recorded physical measurements of the user.

18. The computer program product of claim 1, wherein the plurality of communication messages are selected from a group consisting of: e-mail messages, instant messages, Short Message Service (SMS) messages, and private messages in a social network platform.

19. The computer program product of claim 1, wherein the display comprises an explanation indicating to the user that the external event caused a modification in a score of a communication message.

20. A computerized apparatus having a processor, the processor being adapted to perform the steps of:
obtaining an external event, wherein the external event is external to a communication system through which a user received a plurality of communication messages;
in response to the external event, computing scores to the plurality of communication messages, wherein each score is computed based on a relevancy measurement of a respective communication message to the external event; and
provide a display of the communication system, wherein the display is affected by the computed scores.
